(19) United States
(12) Patent Application Publication
(10) Pub. No.: US 2006/0279193 A1
(43) Pub. Date: Dec. 14, 2006

(54) High-pressure discharge lamp

(76) Inventors: Leo Gustaaf Joanna Emiel Marien, Turnhout (BE); Nancy Jean Caruso, Turnhout (BE)

Correspondence Address: PHILIPS INTELLECTUAL PROPERTY & STANDARDS, P.O. BOX 3001, BRIARCLIFF MANOR, NY, 10510, US

(21) Appl. No.: 10/557,633

(22) PCT Filed: May 13, 2004
(86) PCT No.: PCT/IB04/50679

§ 371 Date: Nov. 17, 2005

(30) Foreign Application Priority Data
May 21, 2003 (EP) 03076518.4
Aug. 15, 2003 (EP) 03102548.9

(51) Int. Cl. H01J 5/48; H01J 5/50

(52) U.S. Cl. 313/318.01

(57) ABSTRACT

A high-pressure discharge lamp has an outer envelope (1) in which a discharge vessel (11) is arranged. The discharge vessel encloses a discharge space (13) with an ionizable filling. The discharge vessel has two mutually opposed neck-shaped portions (2, 3) through which current-supply conductors (4, 5) extend to a pair of electrodes (6, 7) in the discharge space. A lamp base (8) of electrically insulating material supports the discharge vessel (11) via the first and second current-supply conductors. The lamp base is provided with a first (14) and a second (15) contact members connected to the respective first and the second current-supply conductor, respectively. The lamp base (8) and/or the first and/or the second contact member (14, 15) function as an end-of-life device. Preferably, the lamp base is made from soft glass and the first and the second contact member are made from an oxidized nickel-iron-chromium material, preferably from a NiFeCr alloy such as vacovit.

The invention relates to a high-pressure discharge lamp.

High-pressure discharge lamps ranging from 35 to 150 W have become a dominant player in lighting retail applications. Trends have emerged which create positive conditions for range extensions towards lower-lumen packages and/or lower wattages. Lower light levels are being used, for instance in exclusive shops, focusing the light on the goods instead of flooding the area. End users in the market become more and more interested in a uniform quality of the light and would prefer to employ high-pressure discharge lamps instead of using halogen lamps for the low-lumen packages and accent lighting.

Generally, high-pressure discharge lamps of the kind mentioned in the opening paragraph either have a discharge vessel with a ceramic wall or have a quartz glass discharge vessel. Such high-pressure discharge lamps are widely used in practice and combine a high luminous efficacy with favorable color properties. The discharge vessel of the lamp contains one or several metal halides in addition to Hg and a rare gas filling.

A ceramic wall of a discharge vessel in the present description and claims is understood to be a wall made from one of the following materials: monocrystalline metal oxide (for example sapphire), translucent densely sintered polycrystalline metal oxide (for example Al₂O₃, YAG), and translucent densely sintered polycrystalline metal nitride (for example AlN).

A lamp of the kind mentioned in the opening paragraph is known from the English abstract of JP-A 04 002 035. The known discharge lamp comprises a discharge vessel and current-supply conductors supporting the discharge vessel and mounted so as to project from a lamp base of an insulating material. An outer envelope or outer bulb, of which one end is left open, is fixed to the lamp base and encloses the discharge vessel and the current-supply conductors.

A drawback of the known discharge lamp is that at the end of life (EOL) an increase fill pressure in the lamp allows the occurrence of a glow discharge. Such a glow discharge can be sustained for an extended period of time (for example hundreds of hours). This glow discharge may cause sputtering of the connection conductor running alongside the discharge vessel resulting in a mirror around the lamp base, which can trigger the so-called incandescent mode, in which the high-pressure discharge lamp may overheat drastically, often exceeding temperatures for the safe material constraints of the outer envelope and wiring of the discharge lamp.

The invention has for its object to eliminate the above disadvantage wholly or partly. According to the invention, a high-pressure discharge lamp of the kind mentioned in the opening paragraph for this purpose comprises:

an outer envelope in which a discharge vessel is arranged around a longitudinal axis,

the discharge vessel enclosing, in a gastight manner, a discharge space provided with an ionizable filling,

the discharge vessel having a first and a second, mutually opposed neck-shaped portion through which a first and a second current-supply conductor, respectively, extend to a pair of electrodes arranged in the discharge space,

a lamp base of electrically insulating material supporting the discharge vessel via the first and second current-supply conductors,

the lamp base being provided with a first and a second contact member connected to the respective first and second current-supply conductor,

the lamp base and/or the first and/or the second contact member functioning as an end-of-life device.

According to the invention the lamp base, the first and/or the second contact member serve as a fuse in the end-of-life process of the high-pressure discharge lamp. The arc discharge between the first and the second contact member induces stresses in the lamp base. The lamp base starts to melt or to crack under the stresses induced by the arc discharge. The deterioration of the lamp base prevents the incandescent modes discussed above.

A preferred embodiment of the high-pressure discharge lamp according to the invention is characterized in that the lamp base is made from a soft glass, hard glass, or ceramic material. Preferably, the lamp base is made of soft glass. Soft glass has the advantageous property that it has a low softening point and is comparatively sensitive to thermal shocks. When the incandescent mode occurs, the base made of soft glass will deform and crack before excessive temperatures are reached.

Preferably, the lamp base is colored whitish, so as to reflect extra light at useful beam angles, which increases the luminous efficacy of the lamp effectively. Preferably, the lamp base is in the form of a plate.

A preferred embodiment of the high-pressure discharge lamp according to the invention is characterized in that the first and the second contact member are made from a (pre-)oxidized nickel-iron-chromium material. Such a material provides a good thermal match with a base plate made of soft glass. Preferably, the first and the second contact member are made from a NiFeCr alloy such as vacovit.

A preferred embodiment of the high-pressure discharge lamp according to the invention is characterized in that the lamp base supports the outer envelope, and the outer envelope encloses the first and second current-supply conductors and is connected to the lamp base in a gas-tight manner. Controlling of the atmosphere in the outer envelope or outer bulb satisfactorily protects the current-supply conductors against oxidation. By controlling of the atmosphere in the outer envelope is meant evacuating of the outer envelope or providing an air-tight environment which in particular is free from oxidizing agents such as oxygen. Alternatively, controlling of the atmosphere in the outer envelope does not exclude that means are provided in the outer envelope to control the atmosphere in the outer envelope. In an embodiment of the invention, the outer envelope is filled with nitrogen gas comprising, for example, a small percentage of oxygen. Controlling the oxidation of the current-supply conductors makes it possible to position the current-supply conductors relatively close to the discharge vessel. Normally, press seals and/or tipped-off (quartz) tubulations are provided to reduce oxidation of the current-supply conductors, leading to a bulky and lengthy high-pressure discharge lamp. For quartz discharge vessels, the press seal and current-supply conductors are preferably dimensioned such as to attain the desired life by operation in air. Niobium used in ceramic discharge vessels with niobium current-supply conductors oxidizes very quickly at the operating temperatures of the discharge vessel, leading to a very limited life span of the high-pressure discharge lamp.

Preferably, the first and the second contact member issue from the outer envelope. The first contact member in the lamp base is connected to the first current-supply conductor. The second contact member in the lamp base is connected to the second supply conductor via a connection conductor running alongside the discharge vessel. The first and the second contact member provide the mechanical support of the discharge vessel connection and provide the electrical contact between the electrodes in the discharge vessel and the exterior of the high-pressure discharge lamp.

The control of the atmosphere in the outer envelope renders it possible to manufacture a simplified and compact high-pressure discharge lamp. In particular, the length of the high-pressure discharge lamp can be significantly reduced. To this end, a preferred embodiment of the high-pressure discharge lamp is characterized in that the ratio of the distance dₑ between the electrodes to the height h_{dl} of the high-pressure discharge lamp along the longitudinal axis lies in a range of:

$$0.02 \leq \frac{{d}_{e}}{{h}_{dl}} \leq 0.2 .$$

According to this embodiment of the invention, the height h_{dl} of the high-pressure discharge lamp along the longitudinal axis can be smaller than approximately 50 mm for a distance dₑ between the electrodes ranging from approximately 1 mm to approximately 10 mm.

A preferred embodiment of the high-pressure discharge lamp according to the invention is characterized in that an exhaust tube for evacuating the outer envelope is provided in the lamp base or in the outer envelope. This has the advantage that the outer envelope can be evacuated via the exhaust tube after the discharge vessel and the outer envelope have been mounted on the lamp base of the high-pressure discharge lamp. In a further preferred embodiment, the exhaust tube also forms a feed-through element to a current-supply conductor of the discharge vessel of the lamp. This has the advantage of a simpler lamp construction.

The lamp base can be manufactured with a high dimensional accuracy. It is favorable when the lamp base is plane at its surface facing away from the discharge vessel. This surface may be mounted against a (lamp) holder, for example a carrier, and accordingly is a suitable surface for serving as a reference for the position of the discharge vessel.

A preferred embodiment of the high-pressure discharge lamp according to the invention is characterized in that the outer envelope is fastened to the lamp base by means of an enamel. Preferably, the enamel is provided in the form of a previously shaped ring. Using a previously shaped ring considerably simplifies the manufacture of the high-pressure discharge lamp.

The high-pressure discharge lamp according to the invention has the advantage that, when the lamp is in operation, the discharge vessel has optically very compact virtual dimensions, which render the lamp highly suitable for use in compact luminaires. Because of the special construction of the lamp base of the high-pressure discharge lamp according to the invention, the discharge lamp is very suitable for use in a reflector. The relatively highly accurate positioning of the discharge vessel with respect to the base plate and the good dimensional reproducibility of the base plate allow its use in assemblies with different click-fit connections.

The invention will now be explained in more detail with reference to a number of embodiments and a drawing, in which:

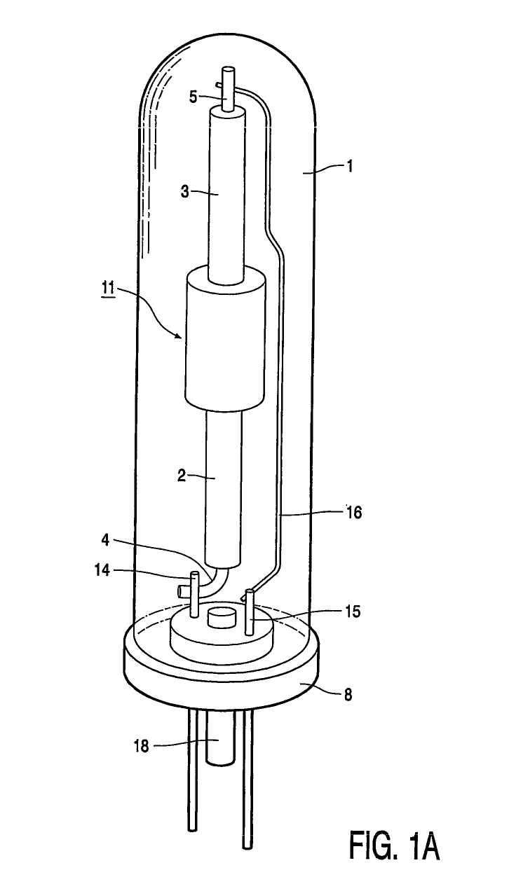

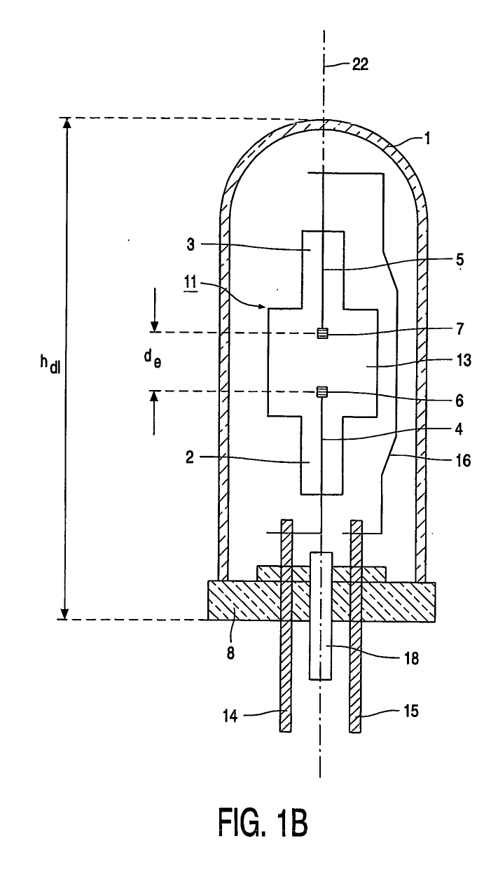

FIG. 1A diagrammatically shows a high-pressure discharge lamp according to the invention;

FIG. 1B a cross-section of the high-pressure discharge lamp as shown in FIG. 1A;

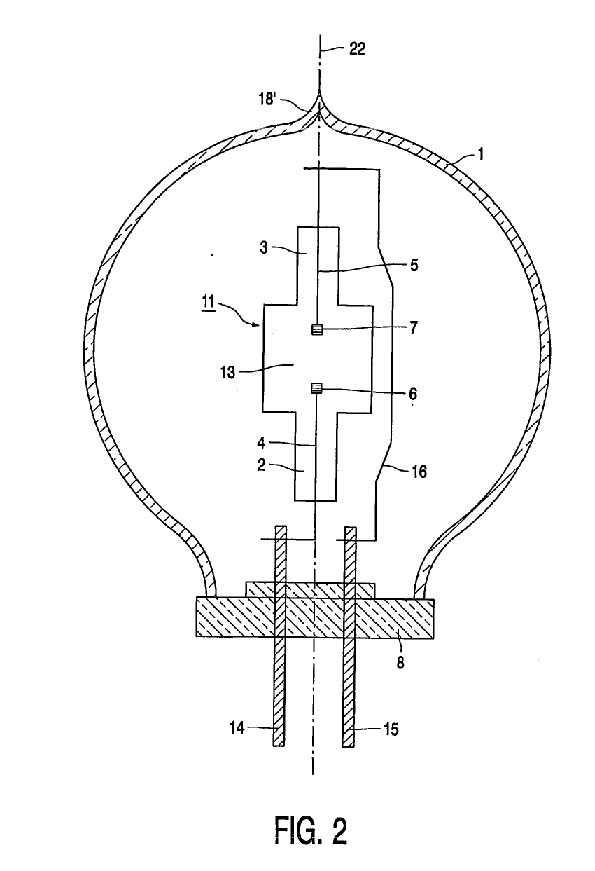

FIG. 2 shows an alternative embodiment of the high-pressure discharge lamp according to the invention;

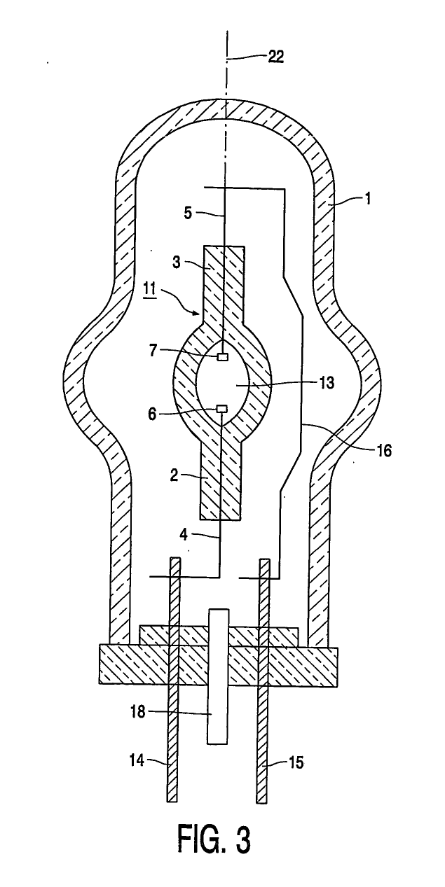

FIG. 3 shows another alternative embodiment of the high-pressure discharge lamp according to the invention; and

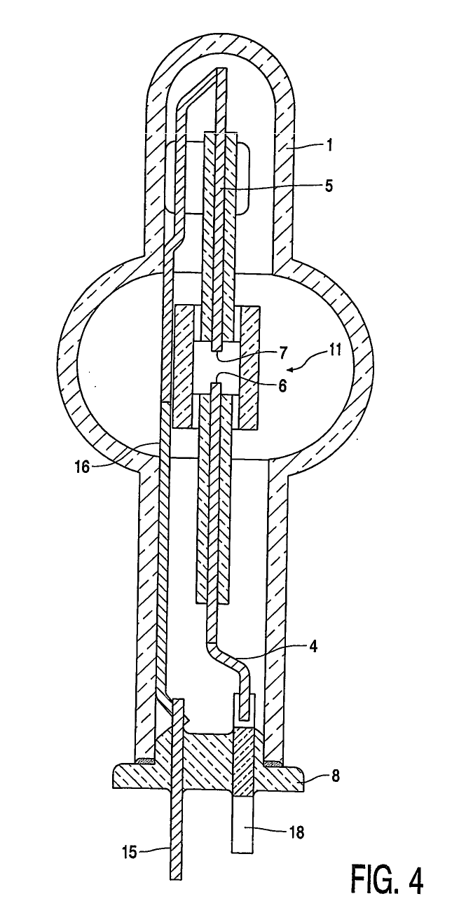

FIG. 4 shows a further alternative embodiment of the high-pressure discharge lamp according to the invention.

The Figs. are purely diagrammatic and not drawn true to scale. Some dimensions are particularly strongly exaggerated for reasons of clarity. Equivalent components have been given the same reference numerals as much as possible in the Figs.

FIG. 1A shows an artist's impression of a high-pressure discharge lamp according to the invention. FIG. 1B diagrammatically shows a cross-section of the high-pressure discharge lamp as shown in FIG. 1A. The high-pressure discharge lamp comprises a discharge vessel 11 arranged around a longitudinal axis 22. The discharge vessel 11 encloses, in a gastight manner, a discharge space 13 provided with an ionizable filling comprising mercury, a metal halide and a rare gas. In the example of FIGS. 1A and 1B, the discharge vessel 11 has a first neck-shaped portion 2 and a second, opposed neck-shaped portion 3, through which portions a first current-supply conductor 4 and a second current-supply conductor 5, respectively, extend to a pair of electrodes 6, 7, which electrodes 6, 7 are arranged in the discharge space 13. The high-pressure discharge lamp is further provided with a lamp base 8 made from an electrically insulating material. The lamp base 8 supports the discharge vessel 11 via the first and second current-supply conductors 4, 5. The lamp base 8 also supports an outer bulb or outer envelope 1. In the example of FIGS. 1A and 1B, the lamp base 8 is provided with a first contact member 14 which is connected to the first current-supply conductor 4. In addition, the lamp base 8 is provided with a second contact member 15 connected to the second supply conductor 5 via a connection conductor 16 running alongside the discharge vessel 11.

According to the invention, the lamp base 8 and the first and/or the second contact member 14, 15 function as an end-of-life device. The lamp base 8 and the first and/or the second contact member 14, 15 serve as a fuse in the end-of-life process of the high-pressure discharge lamp. The arc discharge between the first and the second contact member 14, 15 induces stresses in the lamp base 8. The lamp base 8 starts to melt or to crack under the stresses induced by the arc discharge. The deterioration of the lamp base 8 prevents the so-called incandescent modes.

In an alternative embodiment, at least one contact member is formed by a feed-through tube in the lamp base, allowing one of the current-supply conductors to be fastened in said feed-through tube. Alternatively, two feed-through tubes may be provided in the lamp base. The fastening in these feed-through tubes may be done by resistance welding, laser welding, or crimping. An advantage of the use of feed-through tubes instead of the contact members is that a greater freedom of positioning of the discharge vessel on the longitudinal axis of the high-pressure discharge lamp is attained. This may further improve the precise positioning of the discharge vessel in the outer envelope of the high-pressure discharge lamp.

Preferably, the lamp base 8 is provided as a sintered body, preferably a sintered ceramic body. Preferably, the lamp base 8 is in the form of a plate. The lamp base 8 can be manufactured with a high dimensional accuracy. The lamp base 8 has the additional advantage that it can be made in a light color, for example white or a pale grey. With the use of a material having a light color, light emitted by the discharge vessel 11 will be reflected at useful beam angles, thereby increasing the efficiency of the luminaire or the total efficiency of the high-pressure discharge lamp. It is prevented thereby that the light incident on the lamp base 8 is lost to the light beam to be formed by means of a reflector. In addition, it is favorable when the lamp base 8 has a flat, planar surface facing away from the discharge vessel 11. This surface may be mounted against a (lamp) holder, for example a carrier, for example a reflector, and accordingly is a suitable surface for serving as a reference for positioning the discharge vessel 11. In another favorable embodiment, the surface of the lamp base 8 facing the discharge vessel has a central elevation, which serves to center the discharge vessel 11 and an enamel ring with respect to the lamp base 8 during the manufacture of the high-pressure discharge lamp.

Preferably, the outer envelope 1 is connected to the lamp base 8 in a gas-tight manner. A control of the atmosphere in the outer envelope 1 satisfactorily protects the current-supply conductors 4, 5 against oxidation. As oxidation of the current-supply conductors 4, 5 is prevented, the current-supply conductors 4, 5 can be positioned relatively close to the discharge vessel 11. The control of the atmosphere in the outer envelope makes press seals and/or tipped-off (quartz) tabulations redundant, resulting in a simplified and compact high-pressure discharge lamp. Preferably, an exhaust tube 18 for evacuating the outer envelope 1 is provided in the lamp base 8. In this manner, the outer envelope 1 can be evacuated via the exhaust tube 18 after the discharge vessel 11 and the outer envelope 1 have been mounted on the lamp base 8 of the high-pressure discharge lamp. After being evacuated and, if desired, being provided with the desired atmosphere inside the outer envelope 1, the exhaust tube 18 is sealed off. Preferably, a getter is used inside the outer envelope, for example a mix of water/hydrogen/oxygen to absorb impurities. It is advantageous if the exhaust tube 18 in the lamp base 8 is made from a metal or from a NiFeCr alloy.

Preferably, the outer envelope 1 is made from quartz glass, hard glass, or soft glass. The outer envelope 1 is preferably fastened to the lamp base 8 by means of an enamel of (glass) frit. It is favorable when the enamel is provided in the form of a previously shaped ring. Using such a previously shaped ring considerably improves the accuracy of positioning of the discharge vessel 11 during the manufacture of the high-pressure discharge lamp. The choice of the enamel depends on the material of the outer envelope 1 and on the material of the lamp base 8.

In the example of FIGS. 1A and 1B, a substantially cylindrical outer envelope 1 is provided. FIG. 2 shows an alternative embodiment of the high-pressure discharge lamp according to the invention. In the example of FIG. 2, a substantially spherical outer envelope 1 is provided.

In the examples of FIGS. 1A, 1B and 2, the discharge vessel 11 is made from a ceramic material. In FIG. 2 a sealed exhaust tube 18′ is provided in the outer envelope 1. Providing a glass or quartz tubulation in the outer envelope means that an exhaust tube in the lamp base can be dispensed with. FIG. 3 shows yet another alternative embodiment of the high-pressure discharge lamp according to the invention in which the discharge vessel 11 is made from quartz. In this embodiment the ionizable filling in the discharge space comprises mercury, a metal halide, and a rare gas. In the example of FIG. 3, part of the outer envelope has a substantially spherical shape. In an alternative embodiment shown in FIG. 4, the exhaust tube 18 also forms a feed through tube to which the current-supply conductor 4 is fastened.

The control of the atmosphere in the outer envelope means that a simplified and compact high-pressure discharge lamp can be made. In particular, the length of the high-pressure discharge lamp can be significantly reduced. To this end, a preferred embodiment of the high-pressure discharge lamp is characterized in that the ratio of the distance dₑ between the electrodes to the height h_{dl} of the high-pressure discharge lamp along the longitudinal axis lies in a range of:

$$0.02 \leq \frac{{d}_{e}}{{h}_{dl}} \leq 0.2 .$$

According to the invention, a simplified lamp design is provided which can be used as a building block for a family of products based on a modular capsule lamp. The discharge vessel 11 is supported on the current-supply conductors 4, 5 that are fixedly connected to the base plate 8. The discharge vessel 11 as well as the current-supply conductors 4, 5 are positioned in the outer envelope 1, which is kept under a controlled atmosphere. Elimination of the press seals and and/or tipped-off (quartz) tubulations results in a compact high-pressure discharge lamp. Preferably, the height h_{dl} of the high-pressure discharge lamp is equal to or less than 50 mm, preferably less than 40 mm. In addition, positioning issues of the discharge vessel 11 are eliminated owing to the more controlled manufacture of the high-pressure discharge lamp with respect to the longitudinal axis 22 and, in addition, the discharge vessel 11 can be accurately positioned in a plane orthogonal to the longitudinal axis 22.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A high-pressure discharge lamp comprising:
an outer envelope (1) in which a discharge vessel (11) is arranged around a longitudinal axis (22),
the discharge vessel (11) enclosing, in a gastight manner, a discharge space (13) provided with an ionizable filling,
the discharge vessel (11) having a first (2) and a second (3) mutually opposed neck-shaped portion through which a first (4) and a second (5) current-supply conductor, respectively, extend to a pair of electrodes (6, 7) arranged in the discharge space (13),
a lamp base (8) of electrically insulating material supporting the discharge vessel (11) via the first and second current-supply conductors (4, 5),
the lamp base (8) being provided with a first (14) and a second (15) contact member connected to the respective first and second current-supply conductor (4, 5),
the lamp base (8), and or the first and/or the second contact member (14, 15) functioning as an end-of-life device.

2. A high-pressure discharge lamp as claimed in claim 1, characterized in that the lamp base (8) is made from a soft glass, hard glass, or ceramic material.

3. A high-pressure discharge lamp as claimed in claim 1, characterized in that the first and the second contact member (14, 15) are made from an oxidized nickel-iron-chromium material.

4. A high-pressure discharge lamp as claimed in claim 3, characterized in that the first and the second contact member (14, 15) are made from a NiFeCr alloy.

5. A high-pressure discharge lamp as claimed in claim 1, characterized in that the lamp base (8) supports the outer envelope (1), the outer envelope (1) encloses the first and second current-supply conductors (4, 5), and the outer envelope (1) is connected to the lamp base (8) in a gas-tight manner.

6. A high-pressure discharge lamp as claimed in claim 5, characterized in that the first and the second contact member (14, 15) issue from the outer envelope (1).

7. A high-pressure discharge lamp as claimed in claim 1, characterized in that an exhaust tube (18, 18′) for evacuating the outer envelope (1) is provided in the lamp base (8) or in the outer envelope (1).

8. A high-pressure discharge lamp as claimed in claim 7, characterized in that the exhaust tube (18) in the lamp base (8) is made from a metal or from a NiFeCr alloy.

9. A high-pressure discharge lamp as claimed in claim 1, characterized in that the ratio of the distance dₑ between the electrodes (6, 7) to the height h_{dl} of the high-pressure discharge lamp along the longitudinal axis (22) lies in a range of:
$$0.02 \leq \frac{{d}_{e}}{{h}_{dl}} \leq 0.2 .$$
